(19) United States
(12) Patent Application Publication
(10) Pub. No.: US 2026/0276420 A1
(43) Pub. Date: Sep. 17, 2026

(54) APPARATUS AND METHODS FOR OBTAINING ACCURATE FLUID FLOW RATES

(71) Applicant: GLOBAL LIFE SCIENCES SOLUTIONS USA LLC, Marlborough, MA (US)

(72) Inventors: Jeffrey SOCHA, Marlborough, MA (US); Prasad BAGIYANATHAN, Bengaluru (IN); Nicholas BROCATO, Marlborough, MA (US)

(73) Assignee: GLOBAL LIFE SCIENCES SOLUTIONS USA LLC, Marlborough, MA (US)

(21) Appl. No.: 19/163,535

(22) PCT Filed: Feb. 21, 2024
(86) PCT No.: PCT/US2024/016600

§ 371 Date: Sep. 9, 2025

(30) Foreign Application Priority Data
Mar. 18, 2023 (IN) 202311018620

(51) Int. Cl. G01F 1/696; G01F 15/02; G01F 15/14

(52) U.S. Cl. CPC G01F 1/6965; G01F 15/02; G01F 15/14

(57) ABSTRACT

A method for obtaining an accurate gas flow rate for a thermal mass flow controller located within an enclosure is provided. The method includes obtaining a measurement of at least one gas within the enclosure, the gas having a thermal conductivity greater or less than a thermal conductivity of air and mitigating effects of the at least one gas on the thermal mass flow controller resulting from the gas's thermal conductivity

### CROSS-REFERENCE TO RELATED APPLICATIONS

This application is a national stage of International Application No. PCT/US2024/016600 filed on Feb. 21, 2024, which claims priority to Indian Patent Application No. 202311018620 filed Mar. 18, 2023, both of which are hereby incorporated by reference in their entirety.

### TECHNICAL FIELD

Embodiments of the invention relate generally to bioprocessing apparatus and methods, and more particularly, to accurately controlling fluid flow into bioprocessing systems and the like.

### DISCUSSION OF ART

Bioprocessing devices such as mixers and bioreactors are often employed to carry out biochemical and/or biological processes and/or manipulate liquids and other products of such processes. Such devices often include flexible or collapsible single-use disposable vessels/bags that are supported by an outer rigid structure such as a stainless-steel shell or housing. The bags are made of thin flexible sheets of plastic film and are positioned within the rigid housing and filled with the desired fluid for processing. The fluid within the bags may require mixing or agitation to prevent settling of particulates at the bottom of the bag In addition to agitation, bioprocessing typically also involves the addition of various fluids (e.g., gases) into the bag. For example, air, oxygen, carbon dioxide, nitrogen, or mixtures thereof, as well as other gases, may be introduced. The gases may be compressed or pumped and are generally used to provide suitable growth and/or reaction conditions for producing a product inside the bag.

In known systems, gases pass through filters, flow meters, and/or valves, which may be controlled by a control system, prior to entering the bag. In particular, thermal mass flow controllers (MFCs) may be utilized to regulate flow of such gases. Thermal MFCs generally include a thermistor at an inlet and at an outlet of a conduit, with a heating element, e.g., a tube heater, located between the two thermistors. In use, the thermal MFC measures a difference in the temperature of the gas at the inlet and at the outlet. This AT is used to derive a flow rate of the gas.

These flow control components are typically housed in a rigid enclosure/cabinet that is adjacent to the housing of the bioprocessing device. As will be appreciated, it is generally desirable that such enclosures are resistant to solids, e.g., dust and dirt, and liquids, e.g., water, and, as a result, they may be relatively tightly sealed and/or minimally vented.

Gas flow control equipment, e.g., CO₂ or other gas fittings/valves/tubes, may, however, leak such that gases flowing through the equipment enter into the enclosure. This results in the enclosure having a gas mixture with a thermal conductivity that is not representative of air. This is potentially problematic as thermal MFCs are calibrated assuming that the ambient air outside of the heated conduit is, in fact, air, and cannot detect changes in thermal conductivity. As a result, if the thermal conductivity within the enclosure changes, MFCs may return inaccurate flow rate measurements.

For example, it has been found that for certain enclosures, every 3% increase in the concentration of CO₂ (above ambient air concentrations) within the enclosure resulted in an approximate 1% decrease in measured flow output for all MFCs within the enclosure.

The decreased flow output was not detected by the MFCs which reported flow rates that were inaccurate.

In view of the above, there is a need for systems and methods of obtaining accurate fluid flow rates from flow control components located within an enclosure.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of the possible embodiments. Indeed, the disclosure may encompass a variety of forms that may be similar to or different from the embodiments set forth below.

According to an aspect of the invention, a method for obtaining an accurate gas flow rate for a thermal mass flow controller located within an enclosure is provided. The method includes obtaining a measurement of at least one gas within the enclosure, the gas having a thermal conductivity greater or less than a thermal conductivity of air and mitigating effects of the at least one gas on the thermal mass flow controller resulting from the gas's thermal conductivity.

In an embodiment, the at least one gas is a gas having a thermal conductivity that differs from air by at least 10%, preferably CO₂.

In an embodiment, the measurement is a leak rate of the at least one gas from gas flow control equipment within the enclosure.

In an embodiment, the step of mitigating effects of the at least one gas on the thermal mass flow controller may include purging a quantity of the at least one gas out of the enclosure via a flow of air or N₂.

In an embodiment, the method may further include comparing the measurement of the at least one gas to a threshold and mitigating effects of the at least one gas if the measurement is above or below the threshold.

In an embodiment, the measurement may be a concentration of the at least one gas within the enclosure or a thermal conductivity measurement within the enclosure.

In an embodiment, the step of mitigating effects of the at least one gas on the thermal mass flow controller may include adjusting a pressure of a reference gas to purge the at least one gas.

In an embodiment, the reference gas may be air.

In an embodiment, the step of mitigating effects of the at least one gas on the thermal mass flow controller may include adjusting a calibration curve of the thermal mass flow controller.

In an embodiment, the enclosure may be a sealed cabinet.

In an embodiment, the sealed cabinet may be operatively connected to a bioprocessing vessel.

In an embodiment, the sealed cabinet may have at least an Ingress Protection 44 rating or equivalent.

According to an aspect of the invention, an apparatus for housing gas flow control equipment is provided. The apparatus includes a selectively closeable enclosure having an interior volume configured to receive gas flow control equipment including a plurality of thermal mass flow controllers and a mitigation device configured to mitigate effects of a gas leaking from the gas flow control equipment into the enclosure, on a thermal mass flow controller that result from the gas's thermal conductivity.

In an embodiment, the apparatus may further include at least one thermal mass flow controller located within the enclosure.

In an embodiment, the at least one gas is CO₂.

In an embodiment, the apparatus may further include a sensor configured to obtain a measurement of least one gas within the enclosure, the gas having a thermal conductivity greater or less than a thermal conductivity of air.

In an embodiment, the sensor may be a thermal conductivity sensor.

In an embodiment, the sensor may be a gas concentration sensor.

In an embodiment, the mitigation device may be a source of pressurized air or N₂ configured to purge the at least one gas from the interior volume of the enclosure via a vent, port, or valve formed in the enclosure, based on a known, measured, or expected leak rate of gas flow control equipment in the enclosure.

In an embodiment, the mitigation device may be a pressure regulator configured to adjust a flow rate of the at least one gas within the interior volume of the enclosure.

In an embodiment, the mitigation device may be a controller configured to dynamically adjust a calibration curve of the at least one thermal mass flow controller.

Features which are described in the context of separate aspects and embodiments of the invention may be used together and/or be interchangeable. Similarly, features described in the context of a single embodiment may also be provided separately or in any suitable sub-combination.

### DRAWINGS

The present invention will be better understood from reading the following description of non-limiting embodiments, with reference to the attached drawings, wherein below:

FIG. 1 is a perspective view of a known bioprocessing device and related equipment including an enclosure for flow control equipment.

FIG. 2A is a simplified schematic illustration of an apparatus for obtaining accurate fluid flow rates in accordance with an embodiment of the invention.

FIG. 2B is a simplified schematic illustration of the embodiment of FIG. 2A that includes an alternative mitigation device configuration.

FIG. 3 is a simplified schematic illustration of an apparatus for obtaining accurate fluid flow rates in accordance with an alternative embodiment of the invention.

FIG. 4 is a simplified schematic illustration of an apparatus for obtaining accurate fluid flow rates in accordance with another alternative embodiment of the invention.

FIG. 5 is a graph illustrating a CO₂ setpoint concentration coefficient which may be used to obtain accurate fluid flow rates in accordance with embodiments of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

While embodiments of the invention are described and depicted in connection with vessels and associated equipment used in biological or biochemical processing, e.g., reactors and mixers, embodiments may be suitable for use in a wide variety of industries where flow control equipment, e.g., MFCs, are housed within an enclosure, and, in particular, closed and/or sealed enclosures.

For example, certain embodiments may be suitable for use in semi-conductor/electronics fabrication and oil and gas industries. Certain embodiments may be particularly suitable for enclosures that have an Ingress Protection (IP) rating of 44 (or equivalent) or higher. As will be appreciated, however, embodiments are not limited to specific IP ratings.

Embodiments may also be suitable for use with various types of fluid sensing and sensing equipment and may not be limited to use with thermal MFCs or MFCs in general. Indeed, certain embodiments may be potentially utilized with sensors that are calibrated to properties of air other than thermal conductivity. Likewise, embodiments of the invention are not limited to mitigating the effects of any particular fluid (gas) on thermal conductivity and may be used in connection with a variety of gases, e.g., gases that have a thermal conductivity that deviates from that of air (e.g., by more than 10%), without departing from the scope of the invention.

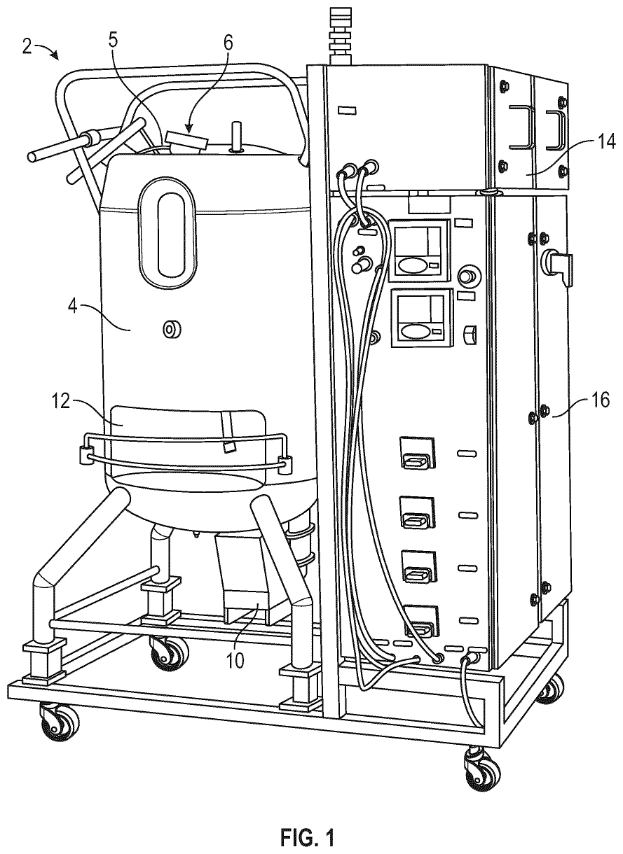

Referring now to FIG. 1, a known bioreactor system 2 is depicted. The bioreactor 2 includes a rigid tank or support structure 4, which may be formed, for example, from stainless steel, polymers, composites, glass, or other metals and may be rectangular or cylindrical in shape, although other shapes may be utilized, as long as it is capable of supporting a single-use flexible mixer or bioprocessing/bioreactor bag. The tank 4 has an upper or top portion 5 that is open to an interior 6 that is configured to receive a vessel, e.g., a flexible, single-use bag.

The bag (not shown) includes a rotatable agitator or impeller assembly that, in use, is magnetically coupled to a drive motor 1. The bag further includes a plurality of ports for the addition of fluids (gases and liquids), for the connection of sample lines, sensors/probes, e.g., temperature and pH, as well as for a drain line.

Generally, probe ports are located on a lower portion of the bag and are accessed through an opening/window 12 in the tank 4, while fluid ports are located at an upper portion of the bag and are accessed via the open top 5 of the tank 4.

The system 2 further includes one or more enclosures 14, 16, which house peristaltic pumps, valves, media bags, control equipment, and power equipment. In some systems, the flow control equipment, e.g., valves and thermal MFCs, are housed in a separate enclosure 14 from other components which may reside in a larger enclosure 16. In known systems, the enclosure 14 contains a pneumatic valve manifold that features a plurality of individual valves for the control of gases such as O₂, N₂, air, and CO₂. These gases are introduced into the flexible, single-use bag, and may be used to promote a cell culturing environment.

As will be appreciated, it is generally desirable to make such enclosures resistant or impervious to solids, such as dust and dirt, and liquids, e.g., water, to protect the flow control equipment and the like. In particular, enclosures may be designed to meet certain criteria set forth in Ingress Protection (IP) ratings.

For example, an enclosure may have an IP rating of 55 (or higher), which means dust cannot enter in sufficient quantity to interfere with the satisfactory operation of equipment in the enclosure, and water projected by a nozzle against the enclosure will have no harmful effects on the equipment. As will be appreciated, such enclosures may be minimally vented, or not vented, and may be relatively tightly sealed to protect the contents of the enclosure.

In testing such enclosures, it was determined that thermal MFCs contained therein had a flow rate (measured via a calibrated flow meter) that was lower than the flow rate reported by the MFC. These flow rate errors varied from >0% to about 25% of the flow rate setpoint. Further testing by individually pressurizing and de-pressurizing O₂, N₂, and CO₂ valves revealed that the MFC flow rate would decrease (MFC reported an incorrect flow rate) in response to CO₂ valve pressurization. It was also determined that CO₂ valves in certain known pneumatic valve manifolds have a leak rate of tens of cc's per minute and that closed/sealed enclosures will concentrate CO₂ in instances where there are CO₂ leaks.

Testing further revealed that for certain enclosures, every 3% increase in the concentration of CO₂ within the enclosure resulted in an approximate 1% reduction in flow rate for all MFCs within the enclosure. The reported MFC flow rates did not reflect the reduction and were inaccurate. Indeed, it was determined that in enclosures with an atmosphere other than air, e.g., CO₂, MFCs do not measure correctly, and subsequently control proportional valves to incorrect flow measurements.

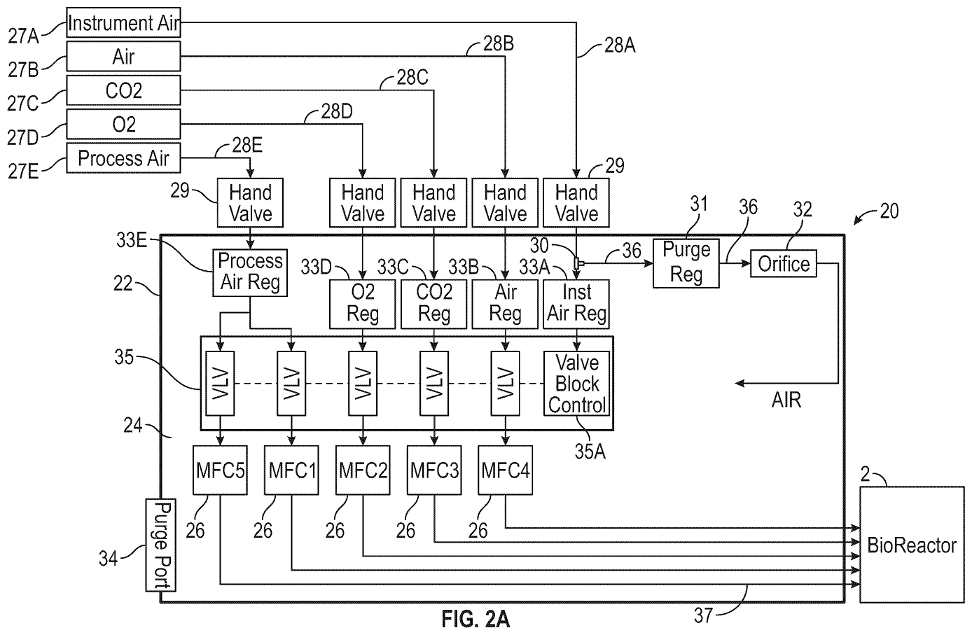

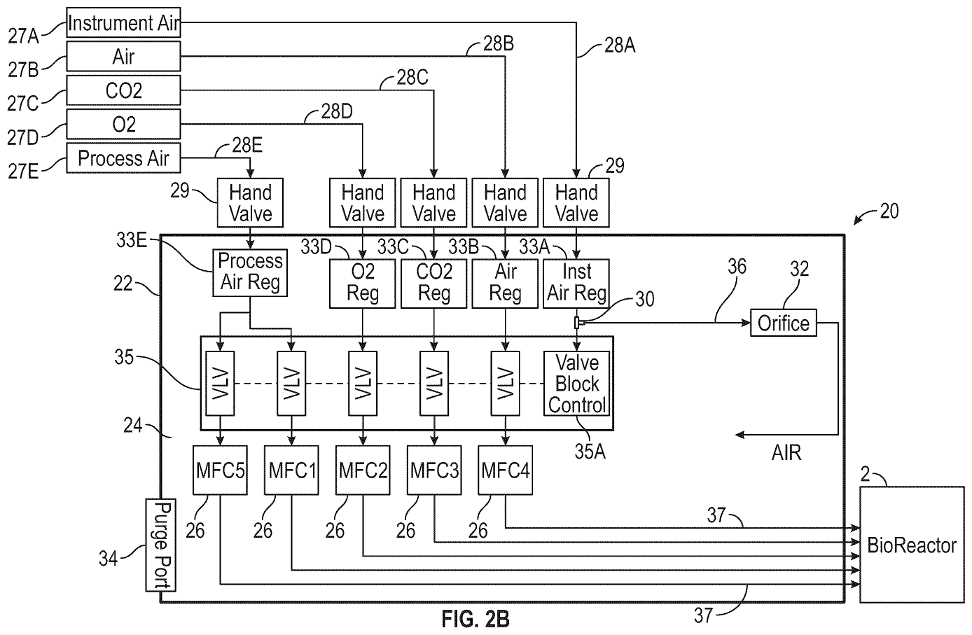

Referring now to FIGS. 2A and 2B, embodiments of an apparatus for housing gas flow control equipment to obtain accurate fluid flow rates are depicted in simplified schematic form. As shown, an apparatus 20 generally includes a closed/closeable enclosure 22 which houses MFCs 26 and other components related to the transfer of fluids into, for example, a bioprocessing device such as a bioreactor or mixer 2. The enclosure 22 may be in the form of a rigid box like structure made of a durable material such as stainless steel, polymers, composites, glass, or other metals. In embodiments, the enclosure 22 is a rectangular metal structure.

Though not depicted, the enclosure 22 has selectively closable doors that are utilized to access the contents of the enclosure 22. In non-limiting embodiments, the enclosure 22 may have more than one (e.g., two) outward opening doors. In specific embodiments, the enclosure 22 is a sealed/sealable cabinet that may include one or more doors that may open outward toward a user.

As mentioned, the enclosure 22 may have an IP 44 rating (or equivalent) or higher and embodiments may be particularly suited for enclosures having such ratings. As will be appreciated, such enclosures may utilize gaskets/seals (e.g., face and/or radial seals) on the closable doors and/or on other openings or apertures in the enclosure 22.

As shown, the enclosure 22 has an interior volume 24 that is configured to receive gas flow control equipment which may include valves, filters, flow meters, and the like. In embodiments, the gas flow control equipment includes a plurality of thermal mass flow controllers, 26. While illustrated with five thermal mass flow controllers, it will be appreciated that embodiments are not limited in this regard and may include greater or fewer than five MFCs depending upon the application and end-usage of the fluids/gasses to be flow controlled. Moreover, although specific gases are illustrated in connection with the MFCs, embodiments are not limited to the depicted gases.

The MFCs 26 are operatively connected to tanks 27A, 27B, 27C, 27D, and 27E that are external to the enclosure 22. The tanks are operatively connected to the MFCs via fluid lines 28A, 28B, 28C, 28D, and 28E, which enter the enclosure 22 through one or more openings or apertures in a wall of the enclosure 22. As will be appreciated, the openings or apertures may include a gasket or like seal.

In a specific embodiment, the fluid lines 28A-28E are connected to hand valves 29 to start or stop the flow of fluid into the enclosure 22. The fluid lines 28A-28E are then connected to pressure regulators 33A-33E, respectively, which regulate pressure/flow of fluids to a valve assembly 35.

In certain embodiments, it may be possible to locate one or more of the aforementioned components, e.g., pressure regulators, valve assembly, outside of the enclosure 22.

As mentioned, the enclosure 22 also includes a valve assembly 35, which is usable to start/stop the flow of gases to the MFCs. As will be appreciated, fluid lines 28A 28D run from the tanks to pressure regulators 33A-33E, then to the valve assembly 35, and then on to the MFCs. A series of output lines 37 run from the MFCs 26 to the bioreactor 2. In embodiments, such valve assemblies 35 may include a pneumatic valve manifold. Other types of valves/valve assemblies may be utilized without departing from the scope of the invention.

In an embodiment, the fluid lines 28A-28D include an instrument air line 28A, whose primary function is to provide air to operate any air actuated instruments/devices in the enclosure or otherwise operatively connected to the bioreactor 2. In the depicted embodiment, the air line 28A runs from a store of air (tank 27A) to an instrument air pressure regulator 33A and then to a valve control block 35A of the valve assembly 35. As will be appreciated, in this context, instrument air is used to open or close the pneumatic valves of the valve assembly 35.

As shown in FIG. 2A, in certain embodiments, the instrument air line 28A has a T-connector or valve 30, located within the enclosure 22, that allows instrument air to be directed into the interior volume 24 to purge leaked gases, e.g., CO₂, from the enclosure 22 as described in greater detail below.

In the embodiment depicted in FIG. 2A, the T-connector 30 is located upstream of the instrument air pressure regulator 33A. A purge line 36 runs from the T-connector 30 to a dedicated purge pressure regulator 31 which is operatively connected to a filtered orifice restrictor 32. The filtered orifice restrictor 32 directs instrument air (or, e.g., N₂) into the interior volume 24 to purge leaked gases that may affect thermal conductivity within the enclosure 22. In particular, the orifice size and air pressure are selected to effectively purge any gas, e.g., CO₂, that has leaked into the interior volume 24. In this manner, the instrument air line 28A (or, in embodiments, a different gas line) functions as a mitigation device to mitigate the effects of gas, having a thermal conductivity different from air, that has leaked into the interior volume 24.

Alternatively, and as depicted in FIG. 2B, the T-connector may be located downstream of the instrument air pressure regulator 33A. In this configuration, the purge line 36 may be directly connected to the filtered orifice restrictor 32 and the instrument air pressure regulator 33A provides pressure sufficient to purge the enclosure 22 of leaked gas.

While depicted with a single orifice operatively connected to a single purge line, in certain embodiments more than one purge line and orifice may be utilized. It may also be possible in certain embodiments, for the feed pressure from a tank, e.g., 27A, coupled with an orifice (or similar device) to provide sufficient pressure such that a separate regulator is unnecessary.

In embodiments, the leaked gas is purged through a purge outlet 34. The outlet 34 may be a vent, port, or valve formed in or on a wall of the enclosure 22. While depicted in a specific location in FIGS. 2A and 2B, the outlet 34 may be in a variety of locations provided suitable purging is attainable.

In specific embodiments, the outlet 34 may be a low cracking pressure relief valve or a low-pressure vent breather. In certain embodiments, it may be possible to utilize other suitable venting mechanisms without departing from the scope of the invention.

As will be appreciated, while FIGS. 2A and 2B depict use of existing instrument air line 28A, embodiments are not so limited. In certain embodiments, a dedicated purging air line may be utilized. As mentioned, the invention is also not limited to the use of air to purge the interior volume 24. In embodiments, N₂ may be utilized for this purpose. Embodiments may utilize devices other than filtered orifices (or T-connectors) to divert gas from an existing line.

In certain embodiments, the apparatus 20 may further include a mechanical purging device within the interior volume 24. Such devices may include fans and the like.

In use, the orifice and/or pressure of air from the instrument air line 28A are selected to mitigate the effects of at least one gas, e.g., CO₂, by obtaining a measurement of the gas. In the present embodiment, obtaining a measurement may involve utilizing known, previously measured, or estimated/predicted leak rates of the gas. These leak rates may be obtained, for example, from the manufacturer of gas flow control equipment and/or may be measured or predicted. In certain embodiments, maximum or “worst-case” gas leak rates may be utilized.

By way of non-limiting example, if the CO₂ gas flow control equipment in the enclosure 22, e.g., the CO₂ regulator 33C, valve assembly 35, MFC 26, and related lines and fittings, have a cumulative leak rate of 10 cc/minute of CO₂ into the interior volume 24, the air line 28 may be set to deliver 1,000 cc/minute to mitigate the effects of the leak rate and purge CO₂ from the enclosure 22.

In the present example, the result will be a 1% concentration of CO₂ in the enclosure, which translates to an approximate 0.33% error in MFC flow rates. As will be appreciated, the percent error that is tolerable will vary by application. For example, in certain applications an error rate of a percent or more may be tolerable, while in other applications much lower MFC error rates may be required.

As will be appreciated, it is generally desirable to mitigate the effects of the at least one gas such that the atmosphere in the enclosure maintains a thermal conductivity and/or specific heat of air or N₂, e.g., ~0.026 W/mK.

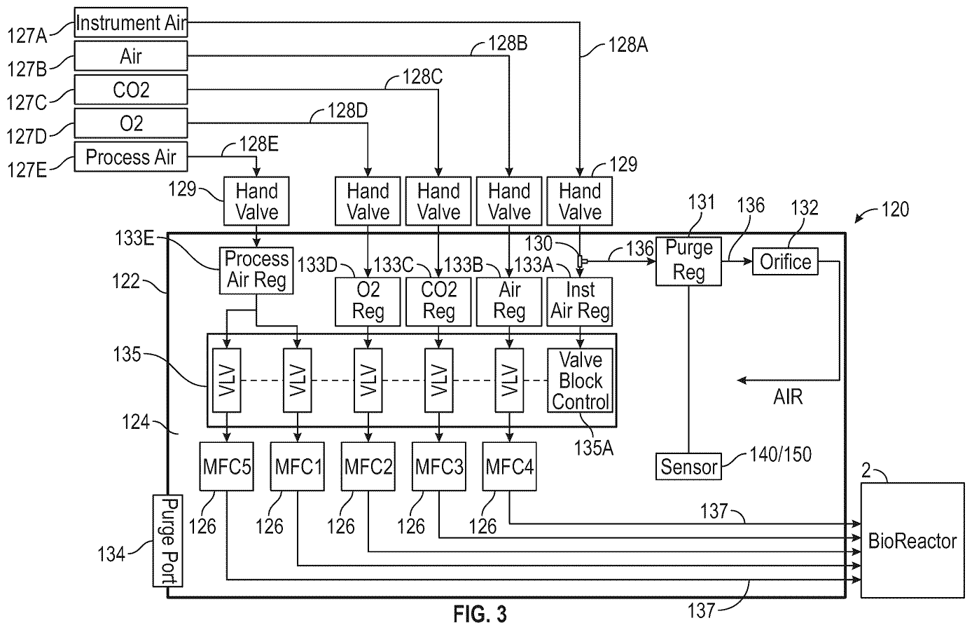

Turning now to FIG. 3, another embodiment of an apparatus for housing gas flow control equipment to obtain accurate fluid flow rates is depicted in simplified schematic form. Like the embodiment of FIGS. 2A and 2B, the apparatus 120 generally includes a closed/closeable enclosure 122 which houses MFCs 126 and other components related to the transfer of fluids into, for example, a bioprocessing device such as a bioreactor or mixer 2.

The MFCs 126 are operatively connected to tanks 127A-127E that are external to the enclosure 122. The tanks are operatively connected to the MFCs via fluid lines 128A, 128B, 128C, 128D, and 128E, which enter the enclosure 122 through one or more openings or apertures in a wall of the enclosure 122. As will be appreciated, the openings or apertures may include a gasket or like seal.

In a specific embodiment, the fluid lines 128A-128E are connected to hand valves 129 to start or stop the flow of fluid into the enclosure 122. The fluid lines 128A 128E are then connected to pressure regulators 133A-133E, respectively, which regulate pressure/flow of fluids to a valve assembly 135.

The apparatus 120 also includes a pneumatic valve assembly 135 that feeds various gases (e.g., O₂, CO₂, air) from the external tanks 127A-127D to the MFCs 126, which then exit the enclosure 122 in route to the bioreactor 2. The apparatus 120 further includes an outlet 134 for mitigating/purging target gases, e.g., those that have a thermal conductivity greater or less than that of air.

Much like the embodiments of FIGS. 2A and 2B, the outlet 134 may be a vent, port, or valve formed on the enclosure and, in specific embodiments, may be a low cracking pressure relief valve or a low-pressure vent breather, though other suitable venting mechanisms may potentially be utilized.

This embodiment, however, utilizes one or more sensors 140, 150 located within the interior volume 124 of the enclosure 122. More specifically, the apparatus 120 includes a thermal conductivity sensor 140 or a gas sensor 150. As will be appreciated, the thermal conductivity sensor 140 measures thermal conductivity of the atmosphere within the enclosure 122, and the gas sensor 150 measures the concentration of gas, e.g., CO₂, in the enclosure 122.

The sensor 140, 150 may be in various locations within the enclosure 120. In certain embodiments, the location of the sensor 140, 150 may be selected based, at least in part, on the density of the gas to be purged. For example, CO₂ has a density greater than air, so a location at the bottom or a lower surface of the enclosure 22 may be selected.

The sensor 140, 150 is operatively connected to a mitigation device, here a purge pressure regulator 131 of a source of a reference gas, e.g., instrument air or N₂, which may be used to mitigate the effects of a gas having a thermal conductivity that departs from that of air. In embodiments, the sensor 140, 150 may be operatively connected to the purge pressure regulator 131 via a controller (not shown). In certain embodiments, the purge pressure regulator 131 is operatively connected to the instrument air line 128A via a purge line 136.

As shown, the purge line 136, in turn, is connected to the instrument air line 128A via a T-connector 130 that is upstream of the instrument air regulator 133A. A filtered orifice restrictor 132 is operatively connected to the purge line 136 downstream of the purge pressure regulator 131.

While a specific instrument air line 128A is illustrated, embodiments can be used with existing air or other gas lines that feed the MFCs, e.g., process air 127E. In certain embodiments, it may be possible to omit the purge pressure regulator 131 and place the T-connector 130 downstream of the instrument air regulator 133A, similar to the configuration of FIG. 2B.

In use, obtaining a measurement of the gas within the enclosure 122 involves using the sensor 140, 150 to read thermal conductivity or gas concentration of the atmosphere of the enclosure. When utilizing a thermal conductivity sensor 140, if the measured conductivity departs from a threshold, e.g., the thermal conductivity of air (or N₂), e.g., is above or below 0.026 W/mK, then the purge pressure regulator 131 (or, in certain embodiments, the instrument air pressure regulator 133A) may be adjusted to increase or decrease a flow of a reference gas (air/N₂) into the enclosure 122 to purge the CO₂ or other offending gas and mitigate the effects thereof.

In embodiments using a gas sensor, if the gas concentration is, for example, above a threshold of 3% CO₂, then the purge pressure regulator 131 may be adjusted to increase or decrease a flow of a reference gas (instrument air/N₂) into the enclosure to purge the CO₂ or other gas to mitigate its effects.

As will be appreciated, in embodiments, the adjustment of the purge pressure regulator 131 (or the instrument air pressure regulator 133A) may be automated via a controller with software and data sufficient to determine the magnitude of adjustment in relation to the measured thermal conductivity or gas concentration. In other embodiments, it may be manually set by a user who has received thermal conductivity or gas concentration measurements.

In certain embodiments, the apparatus 120 may use more than one gas sensor. For example, if the enclosure 122 includes multiple gases that have thermal conductivities that depart from air, more than one specific gas sensor 150 and/or thermal conductivity sensor 140 may be utilized. In other embodiments, the enclosure may include both a gas sensor 150 and a thermal conductivity sensor 140.

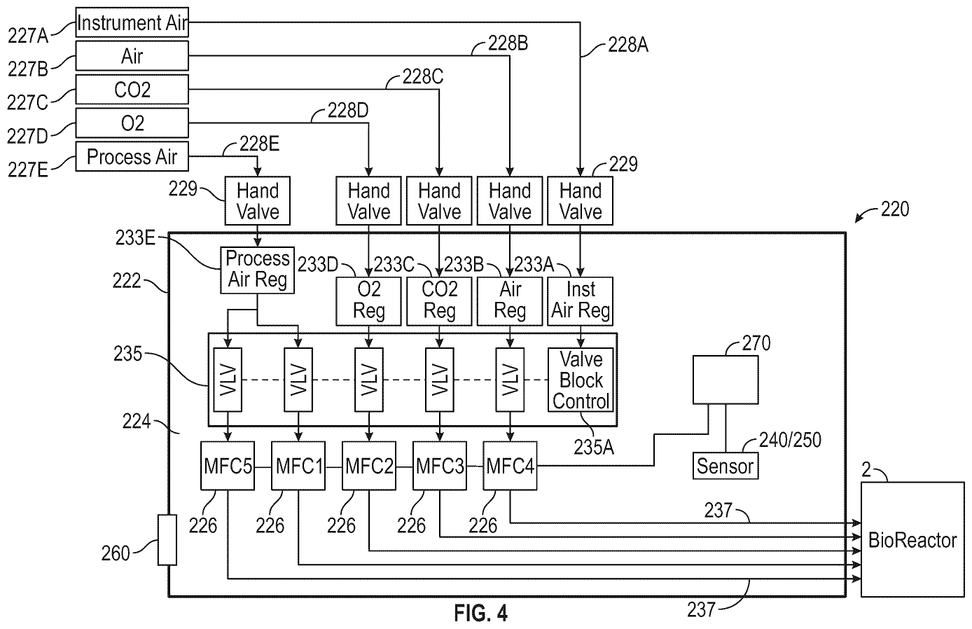

Referring now to FIG. 4, another embodiment of an apparatus for housing gas flow control equipment to obtain accurate fluid flow rates is depicted in simplified schematic form. Like the previous two embodiments, the apparatus 220 generally includes a closed/closeable enclosure 222 which houses MFCs 226 and other components related to the transfer of fluids into, for example, a bioprocessing device such as a bioreactor or mixer 2.

The apparatus 220 has an interior volume 224 that includes a pneumatic valve assembly 235 that feeds various gases (e.g., O₂, CO₂, air) from external sources, e.g., tanks 227A-227E to a plurality of thermal MFCs 226 which then exit the enclosure 224 in route to the intended application, e.g., bioreactor 2.

Similar to the embodiment of FIG. 3, the apparatus 220 utilizes one or more sensors 240, 250 located within the interior volume 224 of the enclosure 222. In particular, the apparatus 220 includes a thermal conductivity sensor 240 or a gas sensor 250 which may be in various locations within the enclosure 220 and, in embodiments, may be placed with consideration given to the density of the gas to be mitigated.

The enclosure 222 is depicted with a vent/port 260. However, in this embodiment the vent 260 may be sized/configured to meet minimum enclosure ventilation requirements, rather than to accommodate the purging of leaked/leaking gas as with outlet 34, 134 of the aforementioned embodiments.

As shown, the sensors 240, 250 are operatively connected to a mitigation device, which here is a controller 270 configured to dynamically (e.g., in real time) adjust a calibration/correction curve (not shown) of one or more thermal MFC 226 in the enclosure 222 to increase or decrease the flow rate to compensate for error due to the presence of a gas with a thermal conductivity that departs from that of air. In embodiments, the sensors 240, 250 may be integral to or a part of the mitigation device.

The controller 270 is operatively connected to the MFCs 226 such that it may adjust the calibration curve. As will be appreciated, the depicted embodiment also includes fluid lines 228A-228E, hand valves 229, pressure regulators 233A-233E, and output lines 237, similar to the previously described embodiments.

The calibration curve is used to correlate temperature change to the flow rate from the thermal MFC. The calibration curve is initially calibrated to air. In embodiments, the calibration curve may be adjusted or corrected to the atmospheric environment within the enclosure 220 as detected by the sensor 240, 250 to compensate for leakage of gas, e.g., CO₂.

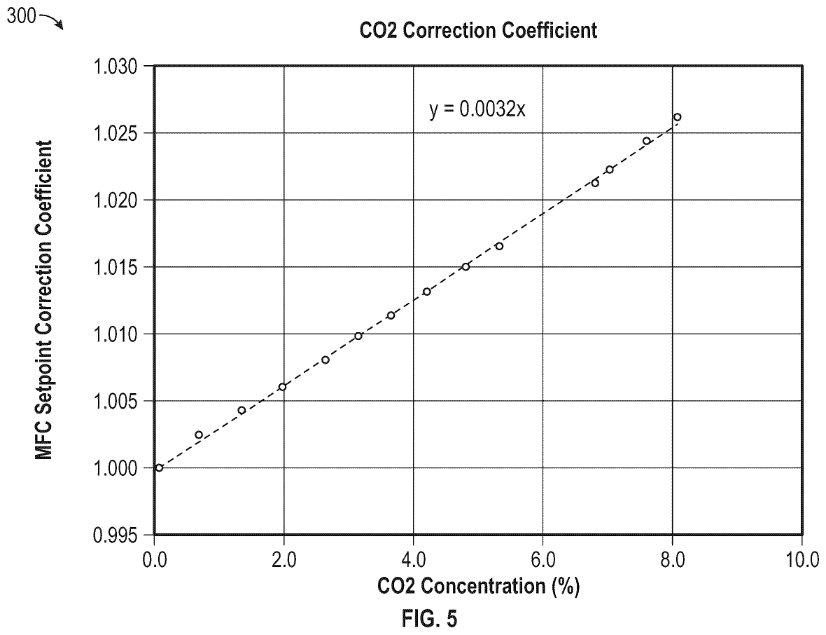

Referring now to FIG. 5, a graph 300 providing one example of the invention usable for adjustment of the thermal MFCs is depicted. In particular, the graph 300 shows CO₂ percent concentration (x) on the x-axis, and an MFC set point correction coefficient (y) on the y-axis. The graph 300 illustrates that for about every 3% of CO₂ in an enclosure, a correction of about 1% (e.g., ~1.010) is necessary to offset the MFC flow rate error. This substantially linear relationship is expressed as the correction coefficient y=0.0032x, which can be utilized for adjusting the calibration curve. As will be appreciated, embodiments of the invention may utilize a lookup table or like methodology for use in calibrating/correcting MFCs based on measured CO₂, particularly where the relationship between leaked gas concentration and MFC error/bias is non-linear.

Embodiments of the invention also contemplate methods for obtaining an accurate gas flow rate for a thermal mass flow controller located within an enclosure. In particular, methods include obtaining a measurement of at least one gas, e.g., CO₂, within the enclosure, the gas having a thermal conductivity greater or less than a thermal conductivity of air, and mitigating effects of the gas on the thermal mass flow controller resulting from the gas's thermal conductivity.

As indicated above, measurements may be a leak rate of the gas from gas flow control equipment within the enclosure. In other embodiments, it may be a concentration of the gas within the enclosure or a thermal conductivity measurement of the atmosphere within the enclosure, both measured via sensors.

In embodiments, mitigating the effects of the at least one gas on the thermal mass flow controller involves purging a quantity of the at least one gas out of the enclosure via a flow of air or N₂.

In embodiments that utilize sensors, methods include comparing the measurement of the gas to a threshold and mitigating effects of the at least one gas if the measurement is above or below the threshold. The threshold may be a gas concentration level or a thermal conductivity of the atmosphere within the enclosure.

To mitigate effects of the gas, methods include adjusting a pressure of a reference gas (air/N₂) within the enclosure to purge the at least one gas and adjusting a calibration/correction curve of one or more thermal mass flow controllers.

In certain methods, the enclosure is a sealed cabinet which may be operatively connected to a bioprocessing vessel and may have an Ingress Protection 44 rating (or equivalent) or higher.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

1. A method for obtaining an accurate gas flow rate for a thermal mass flow controller located within an enclosure comprising the steps of:
obtaining a measurement of at least one gas within the enclosure, the gas having a thermal conductivity greater or less than a thermal conductivity of air; and
mitigating effects of the at least one gas on the thermal mass flow controller resulting from the gas's thermal conductivity.

2. The method of claim 1 wherein the at least one gas is a gas having a thermal conductivity that differs from air by more than 10%, preferably CO₂.

3. The method of claim 1 wherein the measurement is a leak rate of the at least one gas from gas flow control equipment within the enclosure.

4. The method of claim 3 wherein the step of mitigating effects of the at least one gas on the thermal mass flow controller comprises:
purging a quantity of the at least one gas out of the enclosure via a flow of air or N₂.

5. The method of claim 1 further comprising the steps of:
comparing the measurement of the at least one gas to a threshold; and
mitigating effects of the at least one gas if the measurement is above or below the threshold.

6. The method of claim 5 wherein the measurement is a concentration of the at least one gas within the enclosure or a thermal conductivity measurement within the enclosure.

7. The method of claim 5 wherein the step of mitigating effects of the at least one gas on the thermal mass flow controller comprises:
adjusting a pressure of a reference gas to purge the at least one gas.

8. The method of claim 7 wherein the reference gas is air.

9. The method of claim 5 wherein the step of mitigating effects of the at least one gas on the thermal mass flow controller comprises:
adjusting a calibration curve of the thermal mass flow controller.

10. The method of claim 1 wherein the enclosure is a sealed cabinet.

11. The method of claim 10 wherein the sealed cabinet is operatively connected to a bioprocessing vessel.

12. The method of claim 10 wherein the sealed cabinet has at least an Ingress Protection 44 rating or equivalent.

13. An apparatus for housing gas flow control equipment, the apparatus comprising:
a selectively closeable enclosure having an interior volume configured to receive gas flow control equipment including a plurality of thermal mass flow controllers; and
a mitigation device configured to mitigate effects of a gas leaking from the gas flow control equipment into the enclosure on a thermal mass flow controller that result from the gas's thermal conductivity.

14. The apparatus of claim 13 further comprising at least one thermal mass flow controller located within the enclosure.

15. The apparatus of claim 13 wherein the at least one gas is a gas having a thermal conductivity that differs from air by more than 10%, preferably CO₂.

16. The apparatus of claim 13 further comprising:
a sensor configured to obtain a measurement of least one gas within the enclosure, the gas having a thermal conductivity greater or less than a thermal conductivity of air.

17. The apparatus of claim 16 wherein the sensor is a thermal conductivity sensor.

18. The apparatus of claim 16 wherein the sensor is a gas concentration sensor.

19. The apparatus of claim 13 wherein the mitigation device is a source of pressurized air or N₂ configured to purge the at least one gas from the interior volume of the enclosure via a vent, port, or valve formed in the enclosure, based on a known, measured, or expected leak rate of gas flow control equipment in the enclosure.

20. The apparatus of claim 16 wherein the mitigation device is a pressure regulator configured to adjust a flow rate of at least one gas within the interior volume of the enclosure.

21. The apparatus of claim 16 wherein the mitigation device is a controller configured to dynamically adjust a calibration curve of the at least one thermal mass flow controller.
